(19) United States
(12) Patent Application Publication
(10) Pub. No.: US 2002/0068149 A1
(43) Pub. Date: Jun. 6, 2002

(54) Three-dimension ceramics structure and method for producing the same

(76) Inventors: Eiichi Koyama, Kashibashi (JP); Yoshio Tsumura, Sakuraishi (JP); Yoshiaki Nagae, Osaka (JP); Kazuhiro Ueda, Osaka (JP); Yoshiharu Nishino, Narashi (JP); Takeo Nishimura, Kyotoshi (JP)

Correspondence Address: ARMSTRONG,WESTERMAN & HATTORI, LLP, 1725 K STREET, NW., SUITE 1000, WASHINGTON, DC, 20006, US

(21) Appl. No.: 09/726,381

(22) Filed: Dec. 1, 2000

(51) Int. Cl. B32B 3/10; B05D 3/02

(52) U.S. Cl. 428/137; 427/394

(57) ABSTRACT

A method for manufacturing a three-dimension ceramics structure includes the steps of immersing a three-dimension structural fabric into ceramics slurry, and baking the three-dimension structural fabric raised from the ceramics slurry at a predetermined temperature to eliminate organic components of the three-dimension structural fabric to thereby obtain the three-dimension ceramics structure.

### BACKGROUND OF THE INVENTION

1. Field of the Invention

The present invention relates to a three-dimension ceramics structure having three-dimension passages, and more particularly to, a three-dimension ceramics structure preferably used as, for example, a burner head, or a filter such as a deodorizing filter and an air purifying filter on which high-performance materials such as catalyst or adsorbent are adhered. The present invention also relates to a method for producing the aforementioned three-dimension ceramics structure.

2. Description of Related Art

Conventionally, as porous ceramics structure used as catalyst carriers or the like, a foam-like ceramics structure and a honeycomb-like ceramics structure 100 having a number of penetrated holes 10l each surrounded by thin ceramics walls as shown in FIG. 10, are known. The aforementioned foam-like ceramics structure is manufactured by baking an open-cell polyurethane foam in which ceramics solvent is absorbed. On the other hand, the aforementioned honeycomb-like ceramics structure is manufactured by extruding ceramic materials through a die having honeycomb-like bearing holes.

Both the foam-like ceramics structure and the honeycomb-like ceramics structure have such an advantage that they have a large contact surface area to gas or the like because of its porous structure.

However, the aforementioned conventional porous ceramics structure had the below-mentioned drawbacks.

In the aforementioned conventional foam-like ceramics structure, the open-cells easily clog to cause an increased pressure loss. Furthermore, since the foam-like ceramics structure employs a polyurethane foam as a base structure, the cells are uneven in size, which causes property variations of the obtained ceramics structure. Therefore, it is difficult to obtain certain quality required as a final product. In addition, since the foam-like ceramics structure employs a polyurethane foam as its base structure, it is difficult to manufacture a structure having large cells, or large openings, resulting in a limited ceramics structure, which in turn limits the design freedoms and applications. Accordingly, the foam-like ceramics structure cannot be widely used.

On the other hand, in the aforementioned honeycomb-like ceramics structure, fluid such as gas can pass through the ceramics only in the axial direction of the penetrated hole 101. Therefore, it is inevitable that the flow rate at the central portion of each penetrated hole 101 becomes faster than that at the peripheral portion near the peripheral wall of each penetrated hole 101. This deteriorates the contact efficiency between the honeycomb-like ceramics and the fluid passing therethrough. Furthermore, in order to manufacture the honeycomb-like ceramics structure, it is required to prepare a die with a certain structure corresponding to the honeycomb-like ceramics structure. However, since such a die is very expensive, the manufacturing cost of the honeycomb-like ceramics structure increases. Furthermore, when it is required to manufacture a small number of various types of products, which is a recent tendency, it is required to prepare an expensive die for each type of product. Accordingly, the conventional honeycomb-like ceramics structure is not suitable for such a production.

### SUMMARY OF THE INVENTION

An object of the present invention is to provide a three-dimension ceramics structure having three-dimension passages which is low in manufacturing cost, easy in structural control and large in design freedom.

Another object of the present invention is to provide a three-dimension ceramics structure having three-dimension passages which is low in fluid pressure loss and excellent in fluid contact efficiency.

Still another object of the present invention is to provide a manufacturing method of the aforementioned three-dimension ceramics structure.

According to a first aspect of the present invention, a three-dimension ceramics structure including a three-dimension fabric-like ceramics structure obtained by baking an intermediate comprising a three-dimension fabric having continuous apertures and ceramics materials adhered to surfaces of yarns constituting said three-dimension fabric to eliminate organic components of the three-dimension fabric.

In the aforementioned three-dimension ceramics structure, since the three-dimension fabric is used as a starting structure, strictly controlled ceramics structure having a desired size of the openings and distance between connecting poles, can be obtained. Since the three-dimension fabric having continuous apertures can be manufactured with large design flexibility, various shapes and/or sizes of three-dimension ceramics structures can be obtained. Furthermore, the obtained three-dimension ceramics structure has a three-dimension passages, turbulence will be easily generated when fluid passes therethrough, resulting in an excellent fluid contact efficiency. In addition, contrary to a conventional ceramics foam-like structure, no clogging occurs to minimize the pressure loss of fluid passing through the three-dimension ceramics structure. Furthermore, since the fabric is merely utilized as the starting structure to be eliminated by baking, the obtained ceramics structure is light in weight. Since the three-dimension ceramics structure is made of ceramics, it is excellent in heat-resistance, low-thermal expansion and electric-insulation.

The aforementioned three-dimension fabric is preferably comprised of upper and lower fabric layers disposed at a certain distance and each having a plurality of apertures and connecting yarns connecting the upper fabric layer with the lower fabric layers. Since the aforementioned fabric can be manufactured by a knitting machine such as a double-raschel knitting machine or weaving machine, it is possible to obtain a strictly controlled three-dimension ceramics structure. Furthermore, since such a knitting machine or weaving machine can be used to manufacture the fabric, the productivity can be improved and the manufacturing cost can be lowered.

In cases where one or a plurality of intermediate fabric layers each having apertures are disposed between the upper fabric layer and the lower fabric layer, such an intermediate fabric layer (structure) having apertures further promotes the generation of flow turbulence, resulting in an enhanced fluid contact efficiency.

In cases where high-performance materials such as catalyst or absorbent are adhered to the surface of the three-dimension fabric-like ceramics structure, the ceramics structure can be used as, for example, a deodorant member, a filtering member, an exhaust-gas purifying member or a water treating member.

According to a second aspect of the present invention, a method for manufacturing a three-dimension ceramics structure includes the steps of: immersing a three-dimension structural fabric having penetrated apertures into ceramics slurry; and baking the three-dimension structural fabric raised from the ceramics slurry at a predetermined temperature to eliminate organic components of the three-dimension structural fabric to thereby obtain the three-dimension ceramics structure.

The ceramics structure obtained by the aforementioned manufacturing method has the same effect as mentioned above because the obtained structure is the same as the aforementioned structure. In the manufacturing method, since ceramics are adhered onto the fabric by immersing the fabric into ceramics slurry, the ceramics can be evenly adhered, resulting in a three-dimension ceramics structure excellent in mechanical strength. Furthermore, since the adhering of the ceramics is performed by simply immersing the fabric into ceramics slurry, the productivity is excellent.

It is preferable that the ceramics slurry contains organic bonding agents. This enhances the adhering of the ceramics to the fabric.

In cases where the three-dimension structural fabric is comprised of upper and lower fabric layers disposed at a certain distance and each having a plurality of apertures and connecting yarns connecting the upper and lower fabric layers and knitted thereto, the fabric can be manufactured by using a knitting machine or weaving machine. Therefore, the productivity can be further enhanced and a strictly controlled ceramics structure can be obtained.

Furthermore, it is preferable that at least some of the connecting yarns are comprised of a monofilament of from 100 to 2000 denier. Employing the aforementioned monofilament as some of the connecting yarns effectively prevent the connecting yarns from being shrunk due to the ceramics adhered by immersing the connecting yarns into ceramics slurry, which in turn prevents the reduction of the fabric thickness, or the distance between the upper layer and the lower layer. In addition to the above, the dynamic strength, i.e., the mechanical strength between the upper layer and the lower layer can be kept high as a fabric, so that the fabric can be appropriately formed into a desired shape.

As the aforementioned connecting yarn, it is preferable to employ a combined yarn made by combining one or two kinds of yarns selected from the group including a spun yarn and a multifilament yarn with a monofilament yarn of from 100 to 2000 denier.

By employing the aforementioned yarn to be combined with the monofilament yarn, the adherence of the ceramics and the organic bonding agents to the connecting yarns can be further improved. As the aforementioned combined yarn, a twisted yarn, a paralleled yarn or a wrap-yarn can be listed as an example.

As the aforementioned connecting yarn A, it is preferable that one or two kinds of yarns selected from the group including a spun yarn and a multifilament yarn and a monofilament yarn of from 100 to 2000 denier are independently used without using as their combination. Concretely, the former (the spun yarn and/or the multifilament yarn) and the latter (the monofilament yarn) may be disposed at certain intervals. In the similar manner as mentioned above, by combining one or two kinds of yarns selected from the group including a spun yarn and a multifilament yarn with a monofilament yarn, the amount of organic bonding agents and/or ceramics adhered to the connecting yarn can be further increased.

It is preferable to employ the aforementioned combination yarn from the point of view of assuredly adhering enough amount of ceramics to the connecting yarn.

At least some of yarns constituting the upper and lower fabric layers are preferably comprised of one or two kinds of yarns selected from the group including a spun yarn and a multifilament yarn. By employing the aforementioned yarn, the amount of ceramics and/or organic bonding agents adhered to the connecting yarn can be further increased, which gives an excellent dynamic strength to the obtained three-dimension ceramics structure.

The terms “fabric” employed herein are used as terms denoting cloth, textile, texture and/or fabric including knitted fabric and woven fabric.

### BRIEF DESCRIPTION OF THE DRAWINGS

The present invention will be more fully described and better understood from the following description, taken with the appended drawings, in which:

FIG. 1 is a partial perspective view showing a three-dimension ceramics structure according to a first embodiment of the present invention;

FIG. 2 is a cross-sectional view of the aforementioned three-dimensional ceramics structure;

FIG. 3 is a top view showing an upper layer of the aforementioned three-dimensional ceramics structure;

FIG. 4 is a cross-sectional view of a three-dimensional ceramics structure according to another embodiment of the present invention;

FIG. 5 is a cross-sectional view showing a fabric;

FIG. 6 is a plan view showing the upper layer of the aforementioned fabric;

FIG. 7 is a plan view showing an upper (lower) layer of a fabric;

FIG. 8 is a perspective view showing a forming process of a fabric, wherein FIG. 8A shows the fabric to which adhesive agents are spraying, FIG. 8B shows the fabric formed into a cylindrical shape with opposite ends connected each other and FIG. 8C shows the cylindrically shaped fabric disposed within a cylindrical frame member;

FIG. 9 is a schematic view showing a combustion apparatus in which the three-dimension ceramics structure is used as a burner head; and

FIG. 10 is a perspective view showing a conventional porous ceramics structure.

### DETAILED DESCRIPTION OF THE PREFERRED EMBODIMENTS

An embodiment of a three-dimension ceramics structure according to the present invention will be explained based on the drawings.

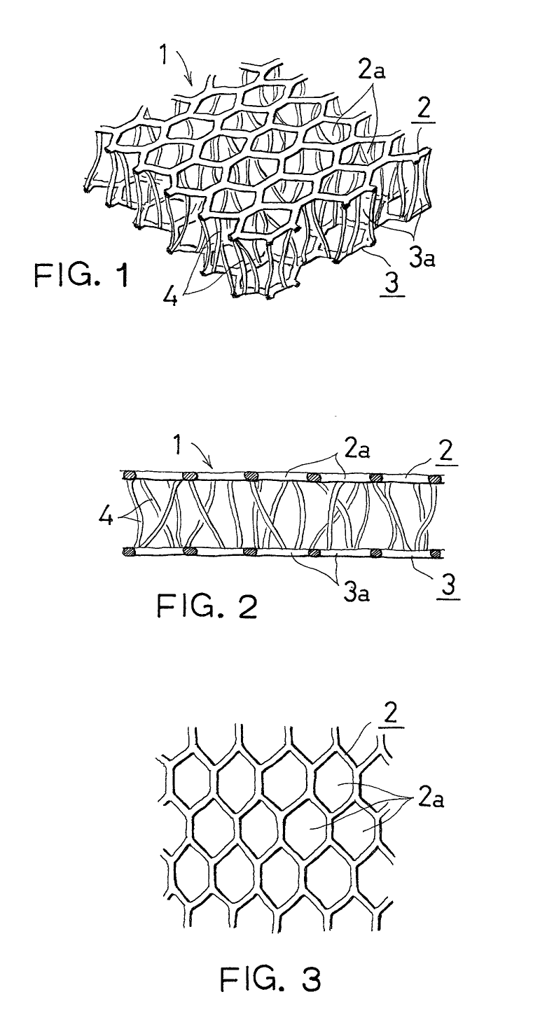

As shown in FIGS. 1 and 2, the three-dimension ceramics structure 1 includes ceramics a ceramics upper layer 2, a ceramics lower layer 3 disposed below the upper layer 2 and a plurality of ceramics connecting pillars 4 interposed between the upper layer 2 and the lower layer 3 so as to connect them. The upper layer 2 is provided with a number of openings 2a and the lower layer 3 is also provided with a number of openings 3a. These openings 2a and 3a are communicated with a number of gaps between the connecting pillars 4, so that the three-dimension ceramics structure 1 has continuous apertures constituting three-dimension passages.

The aforementioned three-dimension ceramics structure 1 is manufactured as follows. In short, the three-dimension ceramics structure 1 is obtained by baking an intermediate comprising a three-dimension fabric having continuous apertures and ceramics materials adhered to surfaces of yarns constituting the three-dimension fabric to eliminate organic components of the three-dimension fabric.

This three-dimension ceramics structure 1 is provided with three-dimension passages which causes flow turbulence. Therefore, the ceramics structure is excellent in fluid contact efficiency. Furthermore, clogging, which often occurs in a conventional form-like ceramics structure, will not occur, which causes only small pressure loss of fluid passing through the structure 1. Since the fabric 20 is only utilized as the starting structure and finally eliminated by the baking process, the obtained ceramics structure becomes lighter by the weight of the fabric. Furthermore, since this three-dimension structure is made of ceramics, it is excellent in heat-resistance, low-thermal expansion and electric-insulation.

The aforementioned three-dimension fabric is not limited to a specially one so long as it has continuous apertures. For example, the fabric can be manufactured by a knitting machine such as a double-raschel knitting machine or a weaving machine such as a velvet loom. A preferable example of such a three-dimension fabric 20 is shown in FIGS. 5 and 6.

Next, a preferred method of manufacturing a three-dimension ceramics fabric structure will be explained.

The three-dimension fabric 20 includes an upper fabric layer 21, a lower fabric layer 22 disposed below the upper fabric layer 21 at a certain distance and connecting yarns 23 connecting the upper and lower fabric layers. In this embodiment, knitted fabric structure is employed as the aforementioned upper and lower layer structures 21 and 22. Each fabric structure 21 and 22 has a plurality of openings 21a, and these openings 21a are communicated with the gaps formed between the connecting yarns 23. As a result, the three-dimension fabric structure as a whole is equipped with continuous holes. The fabric 20 is formed by a double-raschel knitting machine.

The materials constituting the fabric structure 21 and 22 and the connecting yarn 23 are not limited to a specific one, and may be a synthetic yarn or a reproduced yarn made of polyester, polyamide, polyacrylonitrile or the like, or a natural yarn such as wool or silk. Any one of them may be employed independently. Alternatively, some or all of them may be employed as a combination. Above all, it is preferable to employ materials which are easily decomposed at the baking process, i.e., low in resolvable temperature. Most preferably, polyester or polypropylene is employed.

The configuration of each yarn constituting the knitted fabric structures 21 and 22 is not limited to a specific one, and may be, for example, circular in cross-section or non-circular in cross-section. Furthermore, the yarn may be a monofilament yarn, a multifilament yarn, a spun yarn, a crimped yarn, a hydraulically confounded yarn or the combination thereof. Above all, it is preferable to employ one or two kinds of yarns selected from the group including a spun yarn and a multifilament yarn as at least some of the yarns constituting the fabric structure 21, 22. This further enhances the adherence of the ceramics and/or the organic bonding agents to the yarns constituting the knitted fabric structure, which further improves the strength of the obtained three-dimension ceramics structure. In this case, a monofilament yarn may be combined thereto. The form of the combination is also not limited to a specific one, and may be a form of a combined yarns or a simple independent yarn. Furthermore, in cases where a monofilament yarn is employed as a yarn constituting the fabric structure, it is preferable that one or two kinds of yarns selected from the group including a spun yarn and a multifilament yarn as at least some of the connecting yarns 23. This enhances the adhesion of the ceramics and/or the organic bonding agents to the fabric structure because of the knitted portions of the connecting yarns to the fabric structures 21, 22, which strengthens the three-dimension ceramics structure 1.

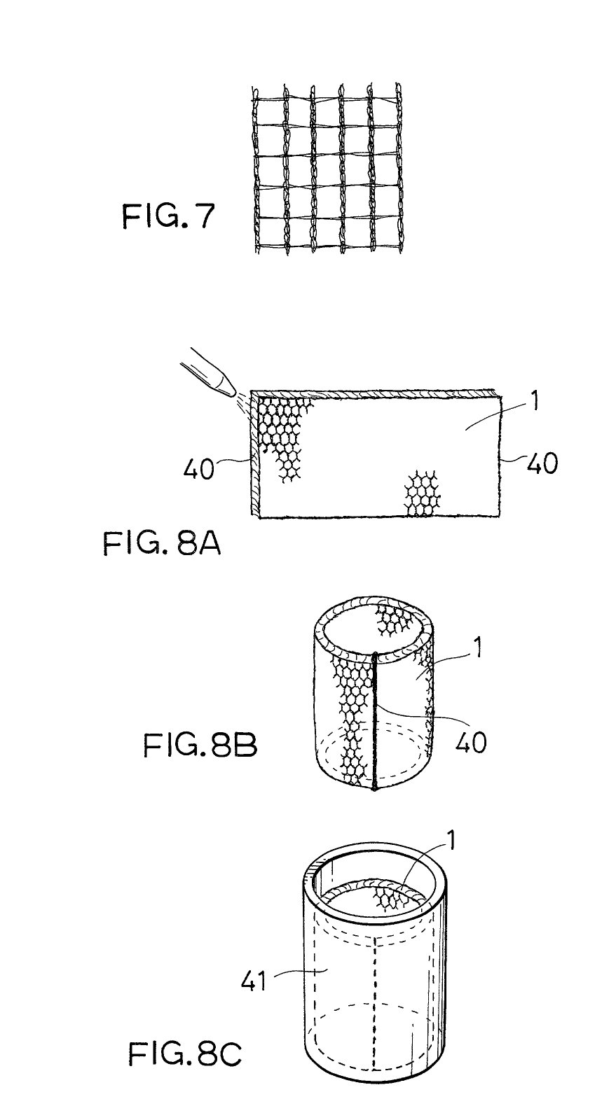

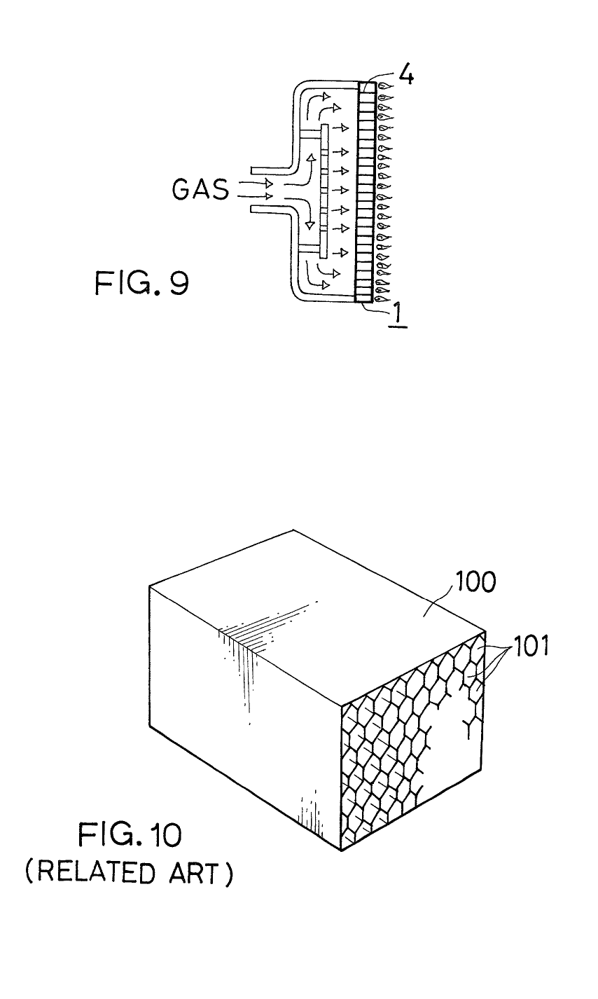

The form of the fabric structure 21, 22 is not limited to a specific one so long as the fabric structure has a plurality of openings. For example, a hexagonal knitted fabric, a markizett knitted fabric (see FIG. 7), a mesh knitted fabric, a plain weave fabric or a sateen weave fabric is employed. In this embodiment, the hexagonal pattern knitted fabric is employed.

The form of the fabric structure and/or the size of the opening of the upper fabric structure may be the same as those of the lower fabric structure. However, from the viewpoint of further improving the fluid contact efficiency, it is preferable that at least one of the form and the size of the opening of the upper fabric structure 21 is different from that of the lower fabric structure 22. This enhances turbulence to be caused in the three-dimension structure, which in turn further improves the contact efficiency of the fluid passing through the continuous holes of the three-dimension ceramics structure.

The arrangement of the connecting yarns 23 between the upper and lower fabric structures 21, 22 is not limited to a specific one, and the distance between the adjacent connecting yarns 23 may be set arbitrarily. Furthermore, the connecting yarns 23 may be disposed between the upper and lower fabric structures 21, 22 such that the connecting yarns 23 are perpendicular to or oblique to the upper and lower fabric structures 21, 22, such that the connecting yarns 23 cross each other, or such that the connecting yarns 23 form a zigzagged shape, a diamond-shape or a honeycomb shape when seen from the side. Needless to say, the combination thereof may also be allowed. Furthermore, the arrangement of the connecting yarns 23 may be partially missing.

Next, the aforementioned three-dimension fabric 20 is immersed into ceramics slurry. However, since oils and/or fats generally are adhered on the yarns constituting the fabric 20, if an immersing treatment is applied to the fabric 20 as it is, the adhesion of ceramics thereto may become insufficient. Therefore, it is preferable to eliminate the oils and/or fats by immersing the fabric 20 into degreasing agent liquid before the immersing treatment. The degreasing agent liquid is not limited to a specific one so long as it can eliminate the oils and/or fats by, for example, dissolving them. As such degreasing agent liquid, phosphorus-free mid-temperature-use alkali degreasing agent liquid including silicate, carbonate and/or sequestering agent (e.g., ethylenediaminetetraacetic acid (EDTA)) as a main gradient can be exemplified.

The three-dimension fabric 20 is immersed into ceramics slurry. The ceramics constituting the ceramics slurry is not specifically limited, and may be, for example, alumina, cordierite, β-spodumene, forsterite, steatite, zircon or mullite. Furthermore, although the grain size of the ceramics constituting the slurry is not specifically limited, it is preferable to fall within the range of from 0.5 to 4.0 μm. Furthermore, although the immersing time is not specifically limited, it is generally enough to immerse the fabric into the slurry for 10 to 30 minutes. The immersing treatment may be repeatedly performed. Generally, water type slurry is preferably used.

It is preferable that the amount of ceramics contained in the aforementioned ceramics slurry falls within the range of from 50 to 80 wt % to the whole slurry. If it is less than 50 wt %, it is not preferable because the adhesive amount to the fabric tends to become insufficient. On the other hand, it exceeds 80 wt %, it is not preferable because the gaps (continuous apertures) of the fabric tend to easily be clogged, which deteriorates the fluid contact efficiency of the obtained structure 1 and increases fluid pressure loss.

It is preferable that the ceramics slurry contains organic bonding agents, so that the adhesive amount of ceramics to the fabric 20 can be increased. The organic bonding agents can be eliminated during the baking process. As such organic bonding agents, polyacrylic acid ester, methylcellulose, polyvinyl alcohol, ethylene-vinylacetate copolymer and wax can be exemplified. The ethylene-vinylacetate copolymer, wax or the like is preferably used in the form of emulsion. It is preferable that the amount of organic bonding agents falls within the range of from 1 to 6 weight parts to ceramics 100 weight parts.

Furthermore, the viscosity of ceramics slurry may be arbitrarily adjusted depending on the thickness or cross-sectional shape of the yarn constituting the three-dimensional fabric 20, the twisting form of yarns or the amount of fabric. Preferably, the viscosity is adjusted so as to fall within the range of from 1000 to 10000 cps.

Next, the fabric 20 raised from the ceramics slurry is baked at a prescribed temperature. The baking process is preferably performed after drying the raised fabric 20 because the adhesion of slurry to the fabric 20 becomes insufficient if the fabric is baked immediately after raising from the slurry without drying it. If necessary, a decomposing process may be performed between the drying process and the baking process. The decomposing process is a heat treatment performed at the temperature between room temperature and 500° C. to eliminate the organic component of the fabric and the organic bonding agents by baking.

Although the baking temperature is arbitrarily set depending on the type of ceramics, it is usually set to from 800 to 1700° C. For example, it is preferable set to from 1580 to 1650° C. in the case of alumina, from 1280 to 1330° C. in the case of cordierite and from 1280 to 1330° C. in the case of β-spodumene. Although the baking time is not specifically limited, it is generally enough to set to 2 to 3 hours.

Through the aforementioned baking process, the organic components of the fabric is baked to be eliminated, which results in the three-dimension ceramics structure 1.

Since the three-dimension fabric 20 having continuous apertures is used as the starting structure of the three-dimension ceramics structure 1, the structure of the obtained three-dimension ceramics structure 1 is basically the same as the three-dimension structure of the fabric 20. In other words, the structure of the three-dimension ceramics structure 1 can be controlled by setting the three-dimension fabric 20 as the starting structure to a desired structure. Since the three-dimension fabric 20 having continuous apertures is large in design freedom, there are such advantages that three-dimension structures of various shapes, sizes and even complex three-dimensional structure can be easily manufactured. Furthermore, it is possible to strictly control the size of opening, or the distance between the connecting yarns of the fabric 20. As a result, a three-dimension ceramics structure 1 having a strictly controlled structure can be obtained by strictly controlling fabric structure. Thus, for example, a structure 1 with openings each having a predetermined size can be obtained, if desired.

In the aforementioned embodiment, the adhering of ceramics is conducted by the slurry immersion. However, in place of the slurry immersion, it is also possible to apply, for example, a known spraying method or evaporation/deposition method. According the slurry immersion method, ceramics can be evenly adhered to an inside of the three-dimensional structure even if the fabric is complex in structure, and ceramics can be enough absorbed in between the yarns in the case of multifilament.

In the aforementioned embodiment, the three-dimension fabric 20 is formed to be a shallow box-shape, and the fabric 20 is subjected to the slurry immersion process and the baking process in the form of the shallow box-shape. Instead, the fabric 20 may be deformed into a desired shape, for example, a cylindrical shape, a conical shape or a spherical shape before these processes, and then subjected to these processes in the form of such a deformed shape. As a result, a three-dimension ceramics structure 1 having the aforementioned predetermined shape can be obtained. An example of forming a fabric into a cylindrical shape is shown in FIGS. 8A to 8C. Bonding agents 40 are applied to opposite end surfaces of the fabric 20, and thereafter, the fabric 20 is formed into a cylindrical shape to abut the opposite end surfaces on which bonding agents are applied. Then, the cylindrically-shaped fabric 20 is inserted into the cylindrical frame 41 made of metal or the like to maintain the shape. In this case, the fabric is required to have an excellent mechanical strength in order to maintain the shape throughout the deforming process. To satisfy this requirement, the connecting yarn 23 should have an appropriate elasticity and repulsion. From this point of view, it is preferable to employ monofilament of from 100 to 2000 denier, more preferably, from 200 to 800 denier as a connecting yarn 23. However, since the monofilament has a smooth surface, the surface area is small. Therefore, the adhesive of ceramics and/or organic bonding agents to the connecting yarns becomes insufficient, resulting in a deterioration of mechanical strength between the upper and lower layers 2, 3.

Therefore, in cases where the fabric 20 is formed into a desired shape, in order to obtain both the aforementioned adhesion and strength characteristics as the connecting yarn 23, it is preferable to use combined yarns formed by combining one or two kinds of yarns selected from the group including a spun yarn and a multifilament yarn with a monofilament yarn of from 100 to 2000 denier. Alternatively, it is preferable to use one or two kinds of yarns selected from the group including a spun yarn and a multifilament yarn and a monofilament yarn of from 100 to 2000 denier, independently, without using them as a combined yarn. As the former yarn, or the combined yarn, although it is not specifically limited to use a specific one, it is preferable to use a twisted yarn, a paralleled yarn and a wrap yarn. Above all, it is more preferable to use a twisted yarn, a paralleled yarn or a wrap yarn in which each constituting yarn is 20 denier or less. As the latter concrete example, the one or two kinds of yarns selected from the group including a spun yarn and a multifilament yarn and the monofilament yarn are disposed at predetermined intervals. In each case, the mechanical strength between the upper and lower layers 2, 3 can be maintained by the monofilament yarn, and the adhesion of ceramics and organic bonding agents to the connecting yarn 23 can be further improved by a capillary phenomenon caused by the spun filament and/or the multifilament yarn. Even in cases where the fabric is not deformed, it is preferable to employ the aforementioned structure.

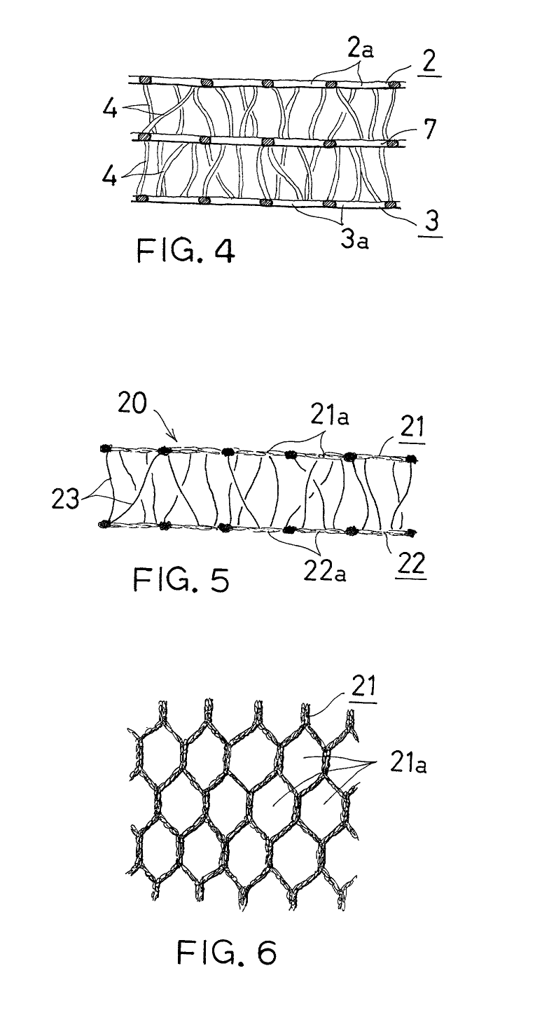

In the aforementioned embodiment, the fabric is comprised of upper and lower layers. However, one or a plurality of intermediate layers may be disposed between the upper layer and the lower layer. For example, as shown in FIG. 4, a three-dimension ceramics structure may be comprised of an ceramics upper layer 2, a ceramics lower layer 3, and one or plurality of ceramics intermediate layers having apertures disposed between the upper and lower layers 2, 3 and ceramics connecting pillars 4 connecting each layers.

The three-dimension ceramics structure 1 according to the present invention is excellent in heat resistance, low thermal expansion and electric insulation. Therefore, by employing cordierite, β-spodumene as the ceramics materials, it can be preferably used as, for example, a burner head for use in a heating apparatus, a hot-water supplying apparatus, a boiler, a drying furnace, an annealing furnace for manufacturing glasses or a die-preheating furnace. In a case where the three-dimension ceramics structure is used as a burner head, in cases burning gas comes out from small apertures, frames become wider since the structure has three-dimension passages. Thus, burning gas burns in plane, resulting in an enhanced combustion efficiency, which in turn can decrease a generation of carbon monoxide. Furthermore, since ceramics materials are excellent in heat resistance, the three-dimension ceramics structure is also excellent in durability.

Although the three-dimension ceramics structure 1 according to the present invention can be used as it is such as the burner head, it can also be used as a filter or a deodorant for use in an air pulifier or a deodorizing apparatus by carrying a high-performance material such as a metallic catalyst like Mn-oxide or Fe-oxide, a light-catalyst like titanium oxide or a biocatalyst like bacteria or enzyme, onto the three-dimension ceramics structure 1. Furthermore, by carrying a metal catalyst, such as a noble metal like Pt or Pd or a transition metal oxide like Fe, Co or Mn, onto the three-dimension ceramics structure 1, the ceramics structure 1 can be used as an exhaust gas purifier or deodorant for use in a plastic forming apparatus or a cooking apparatus. Furthermore, by adhering absorbent such as calcium sulfite onto the ceramics structure 1, the ceramics structure 1 can be used as water treatment.

The use of the three-dimension ceramics structure according to the present invention is not specifically limited to the above. Furthermore, the three-dimension ceramics structure according to the present invention is not limited to the structure obtained by the aforementioned manufacturing method in which the knitted fabric is immersed into slurry.

Concrete examples according to the present invention will be explained.

### EXAMPLE 1

Water-based emulsion of 30 weight parts containing polyacrylic acid ester of 3.0 wt % and methylcellulose of 2.0 wt % as organic bonding agents and 92%-purity alumina powder of 70 weight parts (particle size: 0.5-4.0 μm) were mixed by a pot mill to obtain slurry.

On the other hand, a three-dimension knitted fabric (thickness: 12 mm) as shown in FIGS. 5 and 6 was manufactured by a double-raschel knitting machine (9 gages/inch) by using a twisted yarn as a pile yarn (connecting yarn) comprising a polyester monofilament yarn of 600 denier and a polyester filament yarn consisting of 96 filaments of 1300 denier, and a twisted yarn as a knitted fabric constituting yarn comprising a polyester filament yarn consisting of 96 filaments of 1300 denier. The obtained knitted fabric had upper and lower layers as shown in FIG. 5 and a hexagonal pattern as shown in FIG. 6. Then, as shown in FIG. 8, hot-melt adhesive (polyester resin) was applied to opposite ends of the knitted fabric, and then, the knitted fabric was formed into a cylindrical shape so that the opposite ends were abutted, and inserted into a cylindrical shaped metallic flame. In this inserted sate, the adhesive was hardened to thereby form a cylindrical knitted fabric structure having a diameter of 50 mm.

Thereafter, the cylindrical three-dimension knitted fabric was immersed into the aforementioned alumina slurry for 10 minutes, and then raised therefrom to drain the excessive slurry, to thereby form an alumina film on the surface of the knitted fabric. Then, after drying the knitted fabric for 30 minutes at 100° C., the dried knitted fabric was baked for 2 minutes at 1600° C. Thus, an alumina three-dimension structure was obtained. By baking the knitted fabric at 1600° C., the knitted fabric as a starting structure was burned and eliminated.

Next, the aforementioned alumina structure was immersed into a water-based slurry containing chloroplatinic acid of 0.5 wt % and polyvinyl alcohol of 5.0 wt % for 5 minutes. Then, the alumina structure was raised from the slurry and dried for 30 minutes at 100° C. Thereafter, the dried alumina structure was baked for 3 hours at 550° C. Thus, a catalyst carrying a platinum oxide of 0.2 wt % was obtained.

The catalyst performance of the catalyst was analyzed. The analysis revealed that the deodorizing rate of styrene gas was 99.3% under the condition of the space velocity (SV) of 10000H-1 and the catalyst temperature of 300° C., which was improved by 2% in catalyst activation as compared with a conventional spherical alumina catalyst.

### EXAMPLE 2

Water-based emulsion of 25 weight parts containing polyacrylic acid ester of 2.5 wt % and methylcellulose of 2.0 wt % as organic bonding agents and cordierite powder of 75 weight parts (particle size: 0.5-4.0 μm) were mixed by a pot mill to obtain slurry.

A three-dimension knitted fabric (thickness: 12 mm) as shown in FIGS. 5 and 6 was manufactured by using the same materials as in Example 1.

Thereafter, the three-dimension knitted fabric was immersed into the aforementioned cordierite slurry for 30 minutes, and then raised therefrom to drain the excessive slurry, to thereby form a cordierite film on the surface of the knitted fabric. Then, after drying the knitted fabric for 30 minutes at 100° C., the dried knitted fabric was baked for 120 minutes at 1350° C. Thus, a cordierite three-dimension structure (30 mm length×30 mm width×12 mm thickness) was obtained.

The aforementioned cordierite three-dimension structure was used as a burner head for a hot-water supplying apparatus and was compared with a conventional circular-shaped plate type burner head. As a result, it was confirmed that the combustion efficiency was improved by 20% and the generation of carbon monoxide was decreased by 10%.

### EXAMPLE 3

Water-based emulsion of 30 weight parts containing methycellulose of 4.0 wt % as organic bonding agents and β-spodumene powder of 70 weight parts (particle size: 0.5-4.0 μm) were mixed by a pot mill to obtain slurry.

On the other hand, a three-dimension knitted fabric (thickness: 12 mm) as shown in FIGS. 5 and 6 was manufactured by a double-raschel knitting machine (9 gages/inch) by using a twisted yarn as a pile yarn (connecting yarn) comprising a polyester monofilament of 300 denier and an acryl spun yarn of 5.3 count, and a twisted yarn as a knitted fabric constituting yarn comprising a polyester monofilament yarn of 600 denier and two pieces of acryl spun of 10 count. The obtained knitted fabric had upper and lower layers as shown in FIG. 5 and a hexagonal pattern as shown in FIG. 6. Then, the knitted fabric was subjected to a deformation process in the same manner as Example 1 and formed into a cylindrical shape having a diameter of 50 mm.

Thereafter, the cylindrical three-dimension knitted fabric was immersed into the aforementioned β-spodumene slurry for 30 minutes, and then raised therefrom to drain the excessive slurry, to thereby form a β-spodumene film on the surface of the knitted fabric. Then, after drying the knitted fabric for 30 minutes at 100° C., the dried knitted fabric was baked for 120 minutes at 1320° C. Thus, a β-spodumene three-dimension structure was obtained. By baking the knitted fabric at 1320° C., the knitted fabric as a starting structure was burned to be eliminated.

Next, in the same manner as Example 1, a catalyst carrying a platinum oxide of 0.2 wt % on the aforementioned β-spodumene structure was obtained.

Then, the catalyst performance of the catalyst was analyzed. The analysis revealed that the deodorizing rate of formaldehyde gas was 95.8% under the condition of the space velocity (SV) of 10000H-1 and the catalyst temperature of 350° C., which was improved by 5% in catalyst activation as compared with a conventional spherical alumina catalyst.

Since the three-dimension ceramics fabric according to the present invention uses a three-dimension fabric as the starting structure, strictly controlled ceramics structure having a desired size of the openings and distance between the connecting poles can be obtained. Since the three-dimension fabric can be manufactured with large design flexibility, various shapes and/or sizes of three-dimension ceramics structures can be obtained. Furthermore, the obtained three-dimension ceramics structure has a three-dimension passages, turbulence will be easily generated when fluid passes therethrough, resulting in an excellent fluid contact efficiency. In addition, contrary to a conventional ceramics foam-like structure, no clogging occurs to minimize the pressure loss of fluid passing through the three-dimension ceramics structure. Furthermore, since the fabric is merely utilized as the starting structure and finally eliminated by baking, the obtained ceramics structure is light in weight. Since the three-dimension ceramics structure is made of ceramics, it is excellent in heat-resistance, low-thermal expansion and electric-insulation.

In cases where the aforementioned three-dimension fabric is comprised of upper and lower fabric layers disposed at a certain distance and each having a plurality of apertures and connecting yarns connecting the upper fabric layer with the lower fabric layers, since the aforementioned fabric can be manufactured by a knitting machine or a weaving machine, it is possible to obtain a strictly controlled three-dimension ceramics structure and lower the manufacturing cost.

In cases where one or a plurality of fabric layers each having apertures are disposed between the upper fabric layer and the lower fabric layer, since such an intermediate layer (structure) having apertures further promotes the generation of flow turbulence, the fluid contact efficiency can be further improved.

In cases where high-performance materials such as catalyst or absorbent are adhered to the surface of the three-dimension fabric-like ceramics structure, the ceramics structure can be used as, for example, a deodorant member, a filtering member, an exhaust-gas purifying member or a water treating member since the structure is excellent in fluid contact efficiency.

According to the manufacturing method according to the present invention, since ceramics can be evenly adhered onto the fabric, it is possible to manufacture a three-dimension ceramics structure excellent in mechanical strength. Furthermore, since the adhering of the ceramics can be performed by simply immersing the fabric into ceramics slurry, the productivity is excellent. Since an expensive die is not required, the three-dimension ceramics structure can be manufactured at low cost. In addition, since the obtained ceramics structure is the aforementioned three-dimension ceramics structure, the aforementioned effects can be obtained.

In cases where the ceramics slurry contains organic bonding agents, the adhering of the ceramics to the fabric can be enhanced, which further improves the mechanical strength of the obtained three-dimension ceramics structure.

In cases where the three-dimension structural fabric is comprised of upper and lower fabric layers disposed at a certain distance and each having a plurality of apertures and connecting yarns connecting the upper and lower fabric layers and knitted thereto, since the fabric can be manufactured by using a knitting machine or a weaving machine, the productivity can be further enhanced and strictly controlled ceramics structure can be obtained. Furthermore, the three-dimension ceramics structure is excellent in productivity, which lowers the manufacturing cost.

Furthermore, in cases where at least some of the connecting yarns is comprised of a monofilament yarn of from 100 to 2000 denier, employing the aforementioned monofilament as some of the connecting yarns can effectively prevent the connecting yarn from being shrunk due to the ceramics adhered by immersing the connecting yarns into ceramics slurry, which in turn prevents the reduction of the fabric thickness, or the distance between the upper layer and the lower layer. In addition to the above, the dynamic strength, or the mechanical strength, between the upper and lower can be kept high as a fabric, so that the fabric can be appropriately formed into a desired shape.

Furthermore, in cases where a combined yarn made by combining one or two kinds of yarns selected from the group including a spun yarn and a multifilament yarn with a monofilament yarn of from 100 to 2000 denier is employed, the adherence of the ceramics and the organic bonding agents to the connecting yarns can be further improved, which in turn can further improve the mechanical strength between the two layers.

In cases where one or two kinds of yarns selected from the group including a spun yarn and a multifilament yarn and a monofilament yarn of from 100 to 2000 denier are independently used without using as their combination, the mechanical strength between the two layers can be further improved.

In cases where at least some of yarns constituting the upper and lower fabric layers is comprised of one or two kinds of yarns selected from the group including a spun yarn and a multifilament yarn, the amount of ceramics and/or organic bonding agents adhered to the connecting yarn can be further increased, which gives an excellent dynamic strength to the obtained three-dimension ceramics structure.

This application is based on Japanese Patent Application No. H10-324635 filed on Nov. 16, 1998, the disclosure of which is incorporated by reference in its entirety.

The terms and expressions which have been employed herein are used as terms of description and not of limitation, and there is no intent, in the use of such terms and expressions, of excluding any of the equivalents of the features shown and described or portions thereof, but it is recognized that various modifications are possible within the scope of the invention claimed.

What is claimed is:

1. A three-dimension ceramics structure, comprising:
a three-dimension fabric-like ceramics structure obtained by baking an intermediate comprising a three-dimension fabric having continuous apertures and ceramics materials adhered to surfaces of yarns constituting said three-dimension fabric to eliminate organic components of said three-dimension fabric.

2. The three-dimension ceramics structure as recited in claim 1, wherein said three-dimension fabric comprises upper and lower fabric layers disposed at a certain distance and each having a plurality of apertures and connecting yarns connecting said upper fabric layer with said lower fabric layer.

3. The three-dimension ceramics structure as recited in claim 2, further comprising one or a plurality of fabric layers each having apertures and disposed between said upper fabric layer and said lower fabric layer.

4. The three-dimension ceramics structure as recited in claim 1, wherein high-performance material is adhered to a surface of said three-dimension fabric-like ceramics structure.

5. The three-dimension ceramics structure as recited in claim 2, wherein high-performance material is adhered to a surface of said three-dimension fabric-like ceramics structure.

6. The three-dimension ceramics structure as recited in claim 3, wherein high-performance material is adhered to a surface of said three-dimension fabric-like ceramics structure.

7. A method for manufacturing a three-dimension ceramics structure, including the steps of:
immersing a three-dimension structural fabric having penetrated apertures into ceramics slurry; and
baking said three-dimension structural fabric raised from said ceramics slurry at a predetermined temperature to eliminate organic components of said three-dimension structural fabric to thereby obtain said three-dimension ceramics structure.

8. The method for manufacturing a three-dimension ceramics structure as recited in claim 7, wherein said ceramics slurry contains organic bonding agents.

9. The method for manufacturing a three-dimension ceramics structure as recited in claim 7, wherein said three-dimension structural fabric comprises upper and lower fabric layers disposed at a certain distance and each having a plurality of apertures and connecting yarns connecting said upper and lower fabric layers.

10. The method for manufacturing a three-dimension ceramics structure as recited in claim 8, wherein said three-dimension structural fabric comprises upper and lower fabric layers disposed at a certain distance and each having a plurality of apertures and connecting yarns connecting said upper and lower fabric layers.

11. The method for manufacturing a three-dimension ceramics structure as recited in claim 9, wherein at least some of said connecting yarn include a monofilament yarn of from 100 to 2000 denier.

12. The method for manufacturing a three-dimension ceramics structure as recited in claim 11, wherein a combined yarn made by combining one or two kinds of yarns selected from the group including a spun yarn and a multifilament yarn with a monofilament yarn of from 100 to 2000 denier is used as said connecting yarn.

13. The method for manufacturing a three-dimension ceramics structure as recited in claim 11, wherein one or two kinds of yarns selected from the group including a spun yarn and a multifilament yarn and a monofilament yarn of from 100 to 2000 denier are independently used as said connecting yarn, without using as their combination.

14. The method for manufacturing a three-dimension ceramics structure as recited in claim 11, wherein at least some of yarns constituting said upper and lower fabric layers include one or two kinds of yarns selected from the group including a spun yarn and a multifilament yarn.

15. The method for manufacturing a three-dimension ceramics structure as recited in claim 12, wherein at least some of yarns constituting said upper and lower fabric layers include one or two kinds of yarns selected from the group including a spun yarn and a multifilament yarn.

16. The method for manufacturing a three-dimension ceramics structure as recited in claim 13, wherein at least some of yarns constituting said upper and lower fabric layers include one or two kinds of yarns selected from the group including a spun yarn and a multifilament yarn.

17. A three-dimension ceramics structure, comprising a three-dimension fabric-like structure made of ceramics.

18. The three-dimension ceramics structure as recited in claim 17, wherein said fabric-like structure comprises upper and lower fabric-like layers disposed at a certain distance and an intermediate yarn-like connecting layer connecting said upper fabric-like layer with said lower fabric-like layer.

19. The three-dimension ceramics structure as recited in claim 17, further comprising one or a plurality of intermediate fabric-like ceramics layers disposed between said upper and lower fabric-like ceramics layers.

20. The three-dimension ceramics structure as recited in claim 17, wherein high-performance material is adhered to a surface of said fabric-like ceramics structure.

21. The three-dimension ceramics structure as recited in claim 20, wherein said high-performance material is catalyst or adsorbent.
